(19) United States
(12) Patent Application Publication
(10) Pub. No.: US 2025/0233221 A1
(43) Pub. Date: Jul. 17, 2025

(54) PROCESS FOR THE DIRECT RECYCLING OF ELECTRODE MATERIALS FROM SCRAP RESULTING FROM THE PRODUCTION OF LITHIUM-ION BATTERIES

(71) Applicant: HOSOKAWA ALPINE Aktiengesellschaft, Augsburg (DE)

(72) Inventors: Christian EISENBARTH, Donauwörth (DE); Andreas FÖRSTER, Bobingen (DE)

(73) Assignee: HOSOKAWA ALPINE Aktiengesellschaft, Augsburg (DE)

(21) Appl. No.: 19/016,119

(22) Filed: Jan. 10, 2025

(30) Foreign Application Priority Data
Jan. 12, 2024 (DE) 10 2024 000 111.5

(51) Int. Cl. H01M 10/54; C22B 1/00; C22B 1/24

(52) U.S. Cl. CPC H01M 10/54; C22B 1/005; C22B 1/24

(57) ABSTRACT

In a process for the direct recycling of electrode scrap which is yielded as production waste in the production of lithium-ion batteries, a process is to be provided which makes it possible to recycle electrode scrap from LIB production by mechanical stress without adversely changing the active materials so that it can be fed back into production. This is achieved in that the mechanical stressing of the electrode scrap includes pre-crushing the electrode scrap into bulk material and mechanical stressing of the pre-crushed electrode scrap in a conditioned atmosphere in a fluidised bed opposed jet mill.

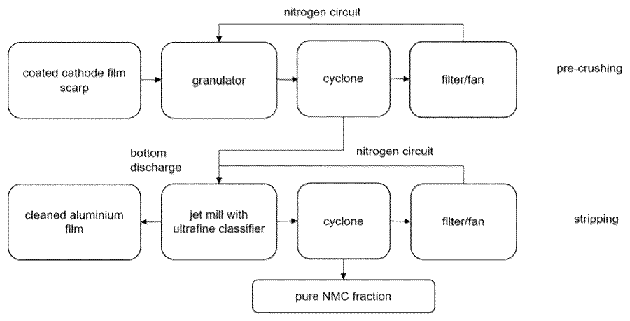

### FIELD OF THE INVENTION

The invention relates to a process for the direct recycling of electrode materials from scrap that results from the production of lithium-ion batteries, which are subjected to mechanical stress and can then be used again for production as shredded, stripped electrode films and separated electrode coating material.

### BACKGROUND

The basic components of a lithium-ion battery are anode, cathode and electrolyte plus a separator. When producing lithium-ion batteries for electromobility, large amounts of waste and rejected coated anode and cathode foil are generated during the production process.

The cathode consists of an aluminium foil that is coated with active materials, e.g. one made of lithium-nickel-manganese-cobalt mixed oxide (NMC), lithium iron phosphate (LFP) or other active cathode materials as well as binders, conductive additives and other additives. The anode consists of a copper foil that is coated with a mixture of graphite, sometimes silicon, binder, conductive additives and other additives.

After the electrodes have been coated and then calendered, large amounts of scrap from coated electrodes are created as the result of edge trimming, rejection of areas with coating defects as well as rejects due to start-up and shut-down processes and incorrect windings, etc.

Up until now, this electrode scrap has been fed to the recycling process of old batteries. There they cannot be treated according to type, so that the active materials are then present as a mixture, the so-called black mass. The scrap is processed metallurgically.

Since this material contains valuable components that have not yet been further used or contaminated, it makes sense to divert it during the production process, to process it and feed the processed active materials back into production.

Initial methods for mechanical processing in the production process are known.

From EP 2 975 686 B1, a method for recycling cathode material from the production of lithium-ion batteries is already known which supplies recycled cathode material, from which recycled cathodes for lithium-ion batteries can be produced without further chemical or physical cleaning steps. It was discovered that the binder does not need to be removed from the recycled cathode material in order to maintain the conductivity properties of the recycled cathode material on a high level. During the treatment, pre-shredded/coarsely crushed/coarse-crushed cathode raw material is processed in an impact mill with subsequent filtering for dedusting and screening, and the aluminium foil can be recycled in one step with a yield of 99%. A hammer mill is used as the impact mill. By using a hammer mill, both types of particles are retained due to their properties with a sufficiently large difference in particle size so that they can be easily separated by screening.

The recycling of electrode scrap is also known from EP 3940872B1.

Here too, recycling takes place during the production process. The waste generated during stamping of the positive or negative electrode plate is recycled. The method includes (a) dry crushing of the electrode scraps including the active material layer, (b) sequential screening of the material from the multi-screen mill to remove the active material from the fragments, and separation of the smallest-size and larger-size active material flakes to obtain a reusable product. The mill can be a pin mill, a disc mill, a granulator or a hammer mill. The active material can be returned directly to the production process without further processing.

### SUMMARY OF THE INVENTION

One aspect of the invention relates to providing an alternative to the state of the art.

Another aspect of the invention relates to providing a method which makes it possible to recycle electrode scrap from LIB production without negatively changing the active materials so that they can be fed directly back into production. Yet another aspect of the invention relates to a method which is optimised for the mechanical stressing of electrode scrap and the separation of the electrode foils from the electrode coating materials.

In the method according to the invention, the electrode scraps are subjected to mechanical stress, whereby they are first pre-crushed into bulk material and then mechanical stressing of the pre-crushed electrode scraps takes place in a conditioned atmosphere in a fluidised bed opposed jet mill. The electrode coating material is mechanically separated from the electrode foils and current collector foils, and is fed back into the production process of lithium-ion batteries.

The binders contained in the coating material mixtures not only lead to cohesion of the active material particles, but also to adhesion of the cathode and anode coatings to the respective metal foil. When processing the coated metal foils, it is important to eliminate this adhesion as much as possible and thus separate the coatings from the metal foils. In a further step, the coating materials can then be separated from the stripped metal foils.

The adhesive strength of the coating material depends largely on the binder type/system.

The electrode scrap to be processed is first pre-crushed in order to bring the product into a state that can be transported and dosed. This is preferably done in a granulator, alternatively with a shredder.

In the subsequent step, the product is treated in a batch process in the fluidised bed of a jet mill.

In this process, the jet mill is not used as a comminution technique for fine powder—its original application—but rather the movement in the fluidised bed, caused by the entry of gas streams through the grinding nozzles, is used to rub the coating off, and the existing classifier is used to retain the electrode film fragments.

To this end, the fluidised bed opposed jet mill is operated at low grinding pressures. The grinding pressure is preferably below 8 bar; this is usual for ultrafine comminution. It is preferably below 6 or 4 bar and particularly preferable is below 2 bar.

The grinding pressure and the residence time of the material in the mill are adjusted so that the process constitutes a wear-free stripping process.

Due to the movement in the fluidised bed, the coating material rubs away from the film fragments, whereby the coating itself is shredded without shredding the film. This type of stress is advantageous because the metal foils are abrasive materials. And for reasons of explosion protection, metal dust is undesirable. After a defined residence time of the product in the mill, the stripped metal foil is emptied into the mill sump and fresh material is filled into the mill.

The active material is continuously discharged from the jet mill as fine material via the classifying wheel. A pure fraction with a very high degree of purity is obtained, which can then be fed back into the original production process. Ideally, the stress is such that the active material has a particle size that corresponds to the particle size of the constituents in production.

In comparison to other processes, there is no need to separate the two fractions in a separate step, e.g. screening, as this step is installed upstream of the fluidised bed opposed jet mill equipped with a classifying wheel.

The electrode coating material is very sensitive to moisture. Moisture causes the active material to degrade, making it no longer suitable for recycling. The stress in the fluidised bed opposed jet mill therefore takes place in a conditioned atmosphere.

The process is carried out in a conditioned atmosphere with a system that includes pre-crushing and stressing in a jet mill. The conditioned atmosphere has a dew point of at least minus 50° C.

Either dry air or inert gas can be used. Nitrogen is preferably used. In this way, explosion protection against possible aluminium dust from the metal foils can be provided.

Over and above this, some components of the electrode scrap are substances that are hazardous to health.

Operation in a nitrogen atmosphere in a closed system (closed loop) therefore serves not only product protection, but also explosion protection and health and environmental protection.

In a further embodiment variant of the invention, the pre-crushing is carried out in a dry atmosphere, whereas the mechanical stress in the fluidised bed opposed jet mill is carried out either in a dry air atmosphere or an inert gas atmosphere.

In another embodiment variant of the invention, the process is further optimised by operating the fluidised bed opposed jet mill in hot gas mode. At high temperatures, the binder softens and the adhesive force between the coating particles and between the coating and the metal foil is reduced, so that lower stress energies are required.

Temperatures are set in the range of the softening temperature of the binder. The temperature of the grinding gas is preferably adjusted so that the best conditions for removal of the coating material exist in the jet mill, for example by increasing the temperature to below the decomposition temperature of the binder.

In this process for the direct recycling of electrodes, the main focus is on the processing of the cathode foil, because, e.g. the NMC mixture is the most valuable material. The processing for this must take place under a dried air atmosphere, as the coating material is very sensitive to moisture and, if possible, there should be no abrasion of the aluminium foil. Furthermore, it is abrasive and explosive (aluminium powder) material.

The properties of the recovered coating material, in particular the particle size, must be adapted to the material flows of the production process so that further processing steps are eliminated if possible and the coating material can be fed from the jet mill direct into production.

The process is also suitable for recycling anode foils.

The process can also be used for cathode foils of all-solid-state batteries.

The invention is not limited to the number of respective treatment steps shown. There is also no need for linear routing of the product flows, i.e. it is possible here to factor in recirculation processes and the like, etc.

### BRIEF DESCRIPTION OF THE DRAWING

Other details, features and advantages of the invention-design process arise from the method set forth in the claims and from the following description of the associated FIGURE in which a preferred embodiment of the invention is shown by way of example.

The FIGURE shows a diagram of the invention-design process with its steps for the recycling of cathode foil.

### DETAILED DESCRIPTION

In the FIGURE, the process with its steps is shown in a flow chart for the example of recycling coated cathode foil waste.

The waste resulting from the production of cathodes in the manufacture of lithium-ion batteries is the starting material for the process pursuant to the present invention.

The coated cathode foils are converted into bulk material in a pre-crushed process under a nitrogen atmosphere. The coated cathode foils are comminuted in a granulator and separated from the nitrogen circuit in a cyclone. The downstream filter is used to remove dust and the fan is used to maintain the nitrogen circuit. The comminuted cathode foils from the cyclone are fed to a jet mill—here a fluidised bed opposed jet mill-under a nitrogen atmosphere for removal of the coating. In the fluidised bed opposed jet mill, the cathode foil fragments are stressed in the fluidised bed but are not comminuted, so that the coating material is rubbed off the metal foil. The coating material can then be further comminuted. The lighter and finer coating material is removed continuously via the classifying wheel and the fines discharge and is fed to a cyclone to separate the pure coating material from the gas stream. It represents the pure NMC faction. The particle size of the coating material can be adjusted as a function of the classifying wheel speed and the gas volume flow. The pure NMC fraction can now be fed back into cathode production for lithium-ion battery manufacture. The coarser, heavier metal foil fraction is extracted from the fluidised bed opposed jet mill via the sump as cleaned aluminium foil. The jet mill is operated in batch mode. The nitrogen stream is freed from dust in the filter and circulated in the stripping process using a fan.

The parameters of the grinding and classification are adjusted in such a way that the fine material removed from the fluidised bed opposed jet mill, i.e. the coating material. with respect to its properties and in particular its particle size, corresponds as completely as possible to the particle size required for the production process.

1. A method for direct recycling of electrode scrap resulting from production of lithium-ion batteries, the method comprising:
provisioning of the electrode scrap comprising electrode foil, electrode coating material and binder,
mechanical stressing of the electrode scrap,
removing the stressed material resulting from the mechanical stress as:
comminuted, stripped electrode foils,
separated electrode coating material,
wherein the mechanical stressing of the electrode scrap includes pre-crushing of the electrode scrap to bulk material, and
wherein the mechanical stressing of the pre-crushed electrode scraps takes place in a conditioned atmosphere in a fluidised bed opposed jet mill.

2. The method of claim 1, wherein the fluidised bed opposed jet mill is operated in batch mode.

3. The method of claim 1, wherein a granulator is used for the pre-crushing.

4. The method of claim 1, wherein the pre-crushing step takes place in a conditioned atmosphere.

5. The method of claim 4, wherein the conditioned atmosphere is a dry air atmosphere.

6. The method of claim 5, wherein the conditioned atmosphere is a dry inert gas atmosphere.

7. The method of claim 6, wherein the dry inert gas atmosphere is a nitrogen atmosphere

8. The method of claim 1, wherein the method is performed in a closed system.

9. The method of claim 1, wherein the method is performed in a closed system under a conditioned atmosphere, which serves not only product protection but also explosion protection and health and/or environmental protection.

10. The method of claim 1, wherein intensity of the stress in the fluidised bed opposed jet mill is adjusted by grinding pressure of grinding nozzles and residence time of the material in the mill.

11. The method of claim 1, wherein particle size of the separated coating material is adjusted as a function of operating parameters of a classifying wheel in the fluidised bed opposed jet mill.

12. The method of claim 1, wherein the fluidised bed opposed jet mill is operated in hot gas mode.

13. The method of claim 1, wherein due to hot temperatures of a hot gas mode of the fluidised bed opposed jet mill, cohesion between active material particles as well as cohesion between active material particles and metal foil generated by the binder are reduced.

14. The method of claim 1, wherein the electrode scraps are cathode foils.
